(19) United States
(12) Patent Application Publication
(10) Pub. No.: US 2010/0214043 A1
(43) Pub. Date: Aug. 26, 2010

(54) High Peak and Average Power-Capable Microwave Window for Rectangular Waveguide

(76) Inventors: Clifton C. Courtney, Cedar Crest, NM (US); Donald E. Voss, Albuquerque, NM (US)

Correspondence Address: DENNIS F ARMIJO;DENNIS F. ARMIJO, P.C., 6300 MONTANO RD. NW, SUITE D, ALBUQUERQUE, NM, 87120, US

(21) Appl. No.: 12/709,074

(22) Filed: Feb. 19, 2010

Related U.S. Application Data
(60) Provisional application No. 61/154,044, filed on Feb. 20, 2009.

(51) Int. Cl. H01P 1/08

(52) U.S. Cl. 333/252

(57) ABSTRACT

A high peak and high average power-capable microwave/radio frequency window for use in rectangular or other waveguide transmission line geometries. The waveguide microwave window provides a physical barrier, or interface, between two regions on either side of the window. The window presents a relatively transparent interface for the microwave signal that is propagating in the waveguide. In an electrical sense the window will exhibit low return loss. The microwave window inhibits multipactor phenomena, suppresses electrical breakdown and transmits high peak power radio frequency signals. The microwave window also provides a mechanism for both passive and active cooling to allow operation at high average power. The applications for the claimed invention include use as part of: High Power Microwave (HPM) generators and systems; HPM sources and systems employed in and by particle accelerators; plasma processing systems; and numerous other applications that utilize high power microwave signals.

### CROSS-REFERENCE TO RELATED APPLICATIONS

This application claims priority to Provisional Application Ser. No. 61/154,044, filed on Feb. 20, 2009 entitled “High Peak Power-Capable Microwave Window for Rectangular Waveguide”.

### BACKGROUND OF THE INVENTION

1. Field of the Invention (Technical Field)

The presently claimed invention relates to a method and apparatus associated with the field of microwave or radio frequency (RF) technology and generally related to microwave waveguides and devices for interconnecting waveguides. More particularly, the presently claimed invention relates to use in a standard rectangular waveguide (with a nominal 2:1 cross sectional aspect ratio) operating in fundamental mode, though the claimed invention is also applicable for use in other waveguide transmission line geometries. The presently claimed invention allows the transport of extremely high peak power, high average power, and intense electromagnetic fields from one waveguide region (with specific environmental conditions, for example a vacuum of 1 micro-Torr) to another (for example, a high pressure environment of 760 Torr). In this context, high power and intense electromagnetic fields refers to electromagnetic fields with intensities of 10 s to 1000 s kV/m (peak) and peak powers of 1 to 1000 s of MW (root mean square)—depending in the waveguide size. The claimed invention permits the transport of intense electromagnetic (EM) fields from a microwave generator (often maintained in a low pressure environment) to an antenna (that must transition EM fields to an ambient air environment or other hermetically isolated region) without electrical breakdown at the microwave window interface. Furthermore, the claimed invention exhibits high microwave signal transmission over a broad frequency bandwidth, and is scalable to all rectangular waveguide geometries operating in fundamental mode. The claimed invention is also compatible with other propagating modes of waveguide transmission lines. The presently claimed invention applies to a broad range of applications, including, but not limited to military directed energy systems and sub-systems, laboratory particle accelerator technologies, industrial plasma processing techniques, RF systems operating on military and civilian spacecraft, and many other terrestrial and extra-terrestrial high power applications involving intense propagated and radiated RF signals.

2. Background Art

Microwave waveguide windows generally serve as an interface between two regions; for example, a window could separate a microwave source region where microwave signals are produced, and an application region where the microwave signals are applied or utilized in one form or another. One reason why a window is needed is that these regions (source and application) are frequently maintained at different physical environments. Typically, it is often required to maintain the microwave source region at low atmospheric pressure (of order micro-Torr) for proper operation, while the application is frequently maintained at another atmospheric pressure, often ambient (˜760 Torr). Microwave windows are regularly used to couple microwave signals from a first waveguide to a second waveguide, though a microwave window can also be used to couple microwave signals, from, say a first waveguide to a first resonant cavity, or a first waveguide to a first free space environment. Operational requirements for a microwave window depend on the application, but often include electrical specifications for operating bandwidth, insertion loss, peak and average power capacity, among others. Operational requirements for a microwave window can also include physical specifications for size, operating temperature, hermetic sealing properties, and others.

The presently claimed invention relates to a microwave window for rectangular waveguide, specifically, standard rectangular waveguide operating in fundamental mode. It is well known in the art that standard rectangular waveguide is characterized by a cross sectional aspect ratio of exactly (in some cases) or approximately (in other cases) 2:1. For example, so-called WR-650 rectangular waveguide (operating frequency band of 1.12 GHz-1.70 GHz) is characterized by interior cross sectional dimensions of 3.250 inches and 6.500 inches. For another example, so-called WR-90 rectangular waveguide (operating frequency band of 8.20 GHz-12.40 GHz) is characterized by interior cross sectional dimensions of 0.400 inches and 0.900 inches. Operation in fundamental mode demands that the propagation or transmission of microwave signals in and along the waveguide occurs such that the electric field vector is: (1) null in the direction of propagation; (2) directed along the axis aligned with the narrow wall of the waveguide in its transverse plane; (3) independent of position along the axis aligned with the narrow wall of the waveguide in its transverse plane; and (4) varies with position along the axis aligned with the broad wall of the waveguide in its transverse plane such that it exhibits nulls at either extreme and a single peak between nulls in the center of the broadwall. Fundamental mode operation regularly defines the operating bandwidth of rectangular waveguide. The geometry and characteristics are described in “Waveguide Handbook”, N. Marcuvitz, Radiation Laboratory Series, Boston Technical Publishers, Vol. 10, 1964.

One type of microwave window well known in the art is that comprised of a half-wave window. The half-wave window is a dielectric region with cross sectional dimensions equal to that of the attached rectangular waveguide sections. Its length (or thickness) in the longitudinal or propagation direction is equal to one-half wavelength of the fundamental mode in the rectangular waveguide at the frequency of operation. More specifically, the length (l_{w}) of the half-wave window is given by the relation

$${l}_{w} = \frac{{λ}_{g 10}}{2} = \frac{1}{2} \frac{{λ}_{0}}{\sqrt{{ɛ}_{r}}} / \sqrt{1 - {( \frac{{λ}_{0}}{2 a \sqrt{{ɛ}_{r}}} )}^{2}} m ,$$

where: λ_{g10}=the wavelength of the microwave signal propagating in fundamental mode in rectangular waveguide with broad and narrowwall dimensions of a and b, respectively; λ₀=the wavelength of the microwave signal in free space; and εᵣ=the relative dielectric constant of the bulk material that comprises the half-wave microwave window. The half-wave window is known to completely pass propagating microwave signals at a frequency with a guide wavelength that is exactly λ_{g10}, where

$${λ}_{g 10} = \frac{{λ}_{0}}{\sqrt{{ɛ}_{r}}} / \sqrt{1 - {( \frac{{λ}_{0}}{2 a \sqrt{{ɛ}_{r}}} )}^{2}}$$

is the wavelength of the propagating signal when in fundamental mode (also known as the TE10 mode). These concepts are taught in many standard references, and in particular in “Microwave Engineering”, D. Pozar, Addison-Wesley, 1990, and have been utilized, for example, in U.S. Pat. No. 3,345,535 to Johnson. By way of example, consider a half-wave widow, built of Teflon® (εᵣ=2.08) in WR-650 rectangular waveguide geometry for a propagating microwave signal oscillating at 1.3 GHz. From above, the length of the half-wave window would be 0.091 m.

A limitation of the half-wave window described above is that its operation is frequency dependent, and operates over a narrow bandwidth (typically a fraction of the nominal empty waveguide bandwidth). U.S. Pat. No. 4,688,009 to Ferguson, U.S. Pat. No. 5,455,085 to Miller, and U.S. Pat. No. 6,965,287 B2 to Mitrovic describe techniques for realizing a broader bandwidth microwave window device. Ferguson taught the use of three window “panes” stacked consecutively along the propagating axis of the rectangular waveguide. Miller taught the use of two “plates” disposed in a rectangular waveguide in such a way that a predefined gap or spacing exists between them. And Mitrovic taught the use of a waveguide window with a half-wave resonant length in combination with a half-wave resonant shunt located at a periphery position to the window. In both instances taught by Ferguson and Miller above, the thickness of the panes and separation of the plates is dictated by resonant wavelength considerations which fundamentally limit the bandwidth of the microwave windows taught there. In neither case are quantitative improvements in bandwidth claimed or reported, while Mitrovic claimed a modest increase in bandwidth and a greater tolerance to variations in the waveguide termination.

U.S. Pat. No. 6,707,017 to Williamson, et al., discloses a microwave window and technique for transmitting intense electromagnetic fields into a plasma processing chamber. The microwave window employs geometries to suppress multipactor along the output surface of the window. The microwave window also employs materials to initiate higher order propagating modes for the stated purpose of reducing the peak electric field associated with the microwave signal. No quantitative improvements in bandwidth or power handling capability are claimed or reported.

U.S. Pat. No. 5,812,040 to Moeller discloses a microwave window and technique for transmitting high average power microwave signals from a first circular waveguide (possibly maintained at a high vacuum environment) to a second circular waveguide (possibly maintained at a high pressure environment). A stack of alternating dielectric material and tapered metal vanes are utilized to realize the microwave window described by Moeller. Impedance matching structures are disposed along the extent of the microwave window to reduce standing waves associated with mismatched sections of transmission lines. Additionally, the tapered metal vanes which extend to the periphery of the circular waveguide are hollow, allowing the introduction and flow of coolant. Moeller claims that the impedance matching techniques and active cooling increase the power handling capability of the resulting waveguide window over conventional designs.

U.S. Pat. No. 7,057,571 B2 to Courtney, et al., discloses a method and technique to dissect rectangular waveguide without reflections and in a manner that preserves the properties of fundamental mode propagation. Furthermore, Courtney taught that a multitude of metal septa could be disposed parallel to the broadwall of rectangular waveguide and entirely across and along the transverse and longitudinal directions of rectangular waveguide without increasing the electric field strength in the guide beyond that normally associated with fundamental mode propagation.

None of these devices, however, disclose or teach the use of a microwave window for fundamental mode propagation in rectangular waveguide that is concurrently high-peak and high-average power capable, operates over a wide bandwidth, is tunable, and scalable to other waveguide bands and rectangular waveguide geometries operating in fundamental mode. Disclosed herein is a unique way to efficiently and over a wide bandwidth transport high power electromagnetic fields from a first rectangular waveguide environment to a second rectangular waveguide environment without electrical breakdown.

### SUMMARY OF THE INVENTION

The need in the art, as described above, is addressed by the currently claimed invention.

It is an object of the claimed invention to teach the use of partitioning of a rectangular waveguide window in such a manner to support the efficient transport of intense electromagnetic fields along connecting rectangular waveguide structures without electrical breakdown. The window serves as an interface between two connecting waveguides. The first region can be a high vacuum environment (of order 1 micro-Torr), while the second region can be a high pressure environment (of order 760 Torr, or more). The purpose of the rectangular waveguide microwave window is to provide an interface between the two environments, operate without electrical breakdown in a high power—high electric field environment and to transport the microwave signal through the window with high efficiency and little attenuation.

It is a further object of the presently claimed invention to teach the use of multiple interfaces, some partitioned as described above, for the purpose of creating a broadband response of the window. The multitude of interfaces would be characterized by specific thicknesses and separation distances that are designed to maximize the operational bandwidth of the microwave waveguide window.

It is a further object of the presently claimed invention to teach the use of passive and active cooling of the window to increase the average power capability of the waveguide window.

A specific implementation of the newly disclosed high peak power-capable rectangular waveguide window utilizes multiple dielectric interfaces, each with a specific thickness and separated by specific distances. The region between the multiple interfaces can be filled with vacuum or a high pressure gas that inhibits electrical flashover (for instance, sulfur hexafluoride). The presently claimed invention teaches the use of a multitude of metallic septums (or septa). Each septum passes through one of the dielectric interfaces and is oriented in a way such that it is everywhere normal to the polarization of the incident electric field. When oriented in such a manner the incident microwave signal can pass through the window without disturbance or electric field enhancement. Each septum extends through the dielectric interface and terminates on the narrowwall of the rectangular waveguide. The septa serve at least two purposes: (1) a septum intercepts any seed electrons and shunts the charge to the waveguide wall; and (2) the septa inhibits the buildup of positive charge on the dielectric interface. These functions inhibit and quench multipactor and allow the rectangular waveguide microwave window to operate at higher microwave power level that would otherwise be possible in the absence of the septa. The interface thicknesses and spacings are specially chosen to maximize the operating bandwidth of the rectangular waveguide microwave window and optimize the transparency of the rectangular waveguide microwave window to the incident and propagating microwave signal.

There are at least two significant innovations in the disclosed rectangular waveguide microwave window. The first innovation is the use of metallic septa which are embedded in or pass through one or more of the dielectric interfaces that constitute the rectangular waveguide microwave window. Each septum is oriented in such a way that it is everywhere normal to the polarization of the incident and propagating electric field. When oriented in such a manner the incident microwave signal can pass without disturbance or electric field enhancement. Each septum extends into and/or through the dielectric interface and terminates on the narrow wall of the rectangular waveguide. The septa intercept seed electrons and shunt the charge to the waveguide wall. In addition, the septa inhibit the buildup of positive charge on the dielectric interface by providing a highly conducting path to DC ground for all intercepted charge. Also, the septa intercept seed electrons before they can gain sufficient energy to cause damage to the various dielectric interfaces of the rectangular waveguide microwave window.

The second innovation is the use of multiple dielectric interfaces to separate low and high pressure regions of the waveguide. The use of multiple dielectric interfaces (which together constitute the disclosed device) allow broadband operation of the rectangular waveguide microwave window, in effect, the multiple interfaces allow the rectangular waveguide microwave window to exhibit characteristics similar to a broadband, bandpass filter. Some of the key features of the presently claimed invention are as follows:
inhibits the initiation of the multipactor phenomena;
quenches the multipactor phenomena should it start;
can be actively or passively cooled;
operates over an extended bandwidth and can be tuned;
is scalable to any rectangular waveguide geometry; and
is source compatible with many high power microwave sources, mating directly in a physical sense with the source's output waveguide, and in an electrical sense with the TE₁₀ mode.

### BRIEF DESCRIPTION OF THE DRAWINGS

The accompanying drawings, which are incorporated into and form a part of the specification, illustrate several embodiments of the presently claimed invention and, together with the description, serve to explain the principles of the invention. The drawings are only for the purpose of illustrating a preferred embodiment of the invention and are not to be construed as limiting the invention. In the drawings:

FIG. 1a depicts the cross section of the geometry of standard rectangular waveguide and the electric field distribution of the TE10 fundamental mode in the xy-plane.

FIG. 1b depicts the cross section of the geometry of standard rectangular waveguide in the yz-plane.

FIG. 1c depicts the cross section of the geometry of standard rectangular waveguide in the xz-plane.

FIG. 2a shows a cut in the xy-plane of a generic microwave window in standard rectangular waveguide.

FIG. 2b shows a cut in the yz-plane of a generic microwave window in standard rectangular waveguide.

FIG. 3 depicts the phenomena of multipactor across a conventional microwave window in a cross sectional cut in the yz-plane.

FIG. 4a is a cross sectional cut in the yz-plane of one embodiment of the new microwave window invention.

FIG. 4b is a cross sectional cut in the xy-plane of one embodiment of the new microwave window invention.

FIG. 5 depicts the inhibition of the phenomena of multipactor across the new microwave window invention in a cross sectional cut in the yz-plane.

FIG. 6a is a cross sectional cut in the yz-plane of a double pane embodiment of the new microwave window invention.

FIG. 6b is a cross sectional cut in the yz-plane of one embodiment of the new microwave window invention that utilize septa that do not extend through their entire longitudinal extent of the window.

### DESCRIPTION OF THE PREFERRED EMBODIMENTS

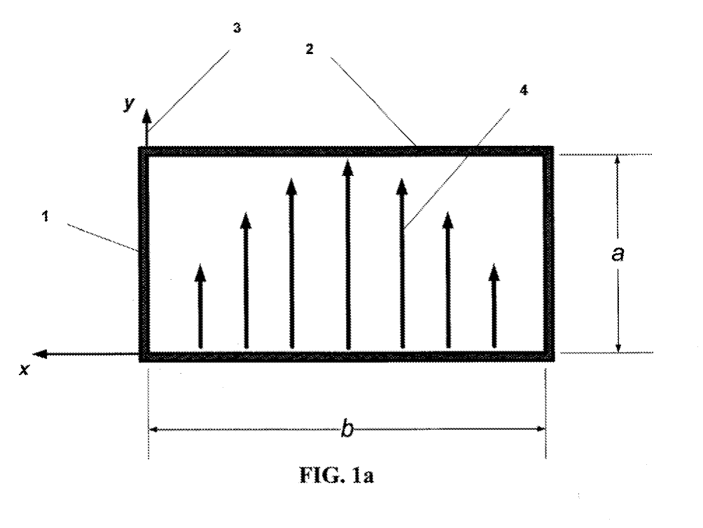

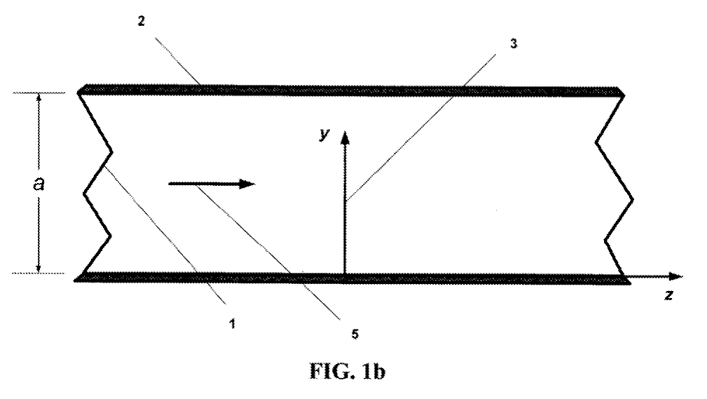

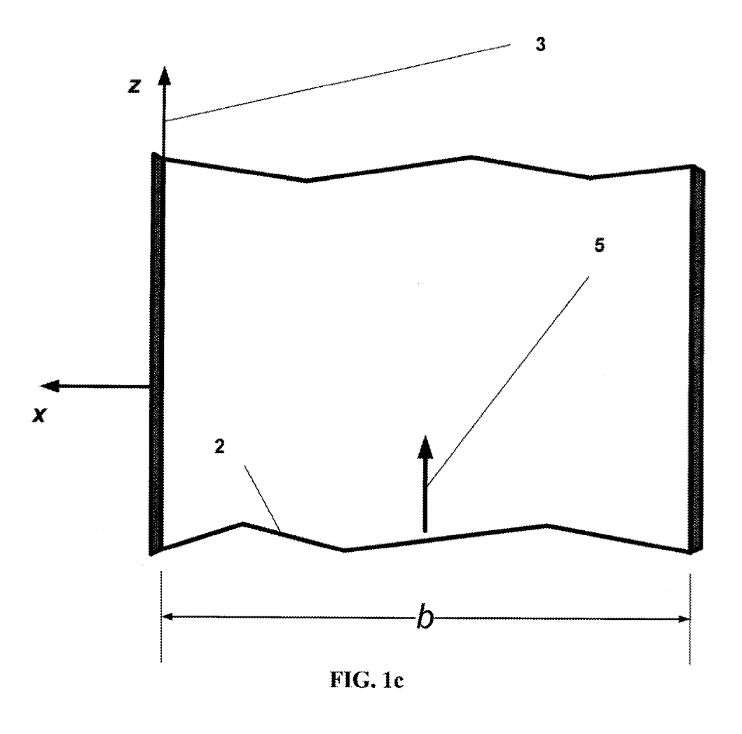

The geometry of rectangular waveguide is shown in the principal plane cross sections in FIGS. 1a, 1b and 1c. The narrowwall 1 has dimension a, while the broadwall 2 has dimension b, b>a, and for standard rectangular waveguide b˜2a. All boundaries of the waveguide are metal and are good electrical conductors. For the claimed invention the rectangular waveguide can be standard (one in which the dimension of the broadwall is approximately twice the dimension of the narrowwall) or non-standard (one in which the dimension of the broadwall is more than twice the dimension of the narrowwall). A standard right-hand coordinate system 3 is assigned to the geometry and is also shown in the figures. As indicated in FIG. 1b, an electromagnetic wave is assumed propagating 5 along the z-axis direction. The mode of the propagating electromagnetic wave is assumed to be that of the TE10 rectangular waveguide mode 4, as shown in FIG. 1a, also known as fundamental mode of the rectangular waveguide. Height of arrows 4 is meant to indicate the relative strength of the electric field as a function of the position along the broad dimension of the waveguide. FIG. 1c indicates the cross sectional geometry of rectangular waveguide in the xz-plane, an electromagnetic wave is assumed propagating 5 along the z-axis direction.

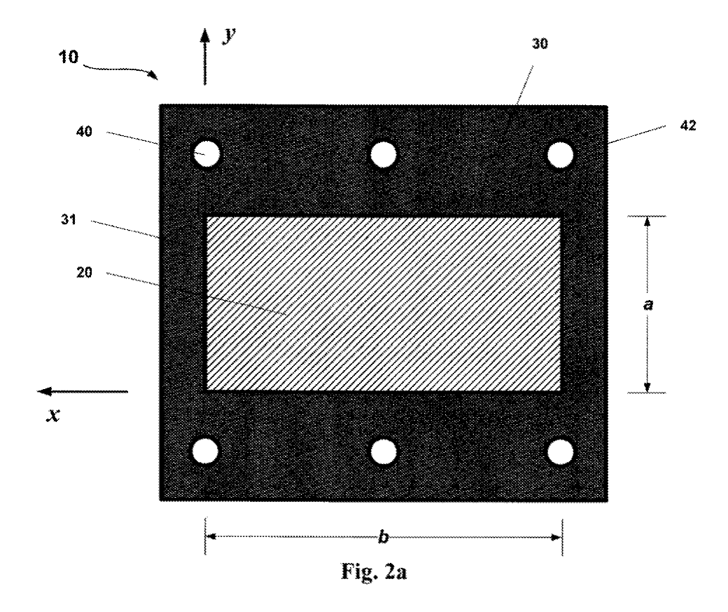

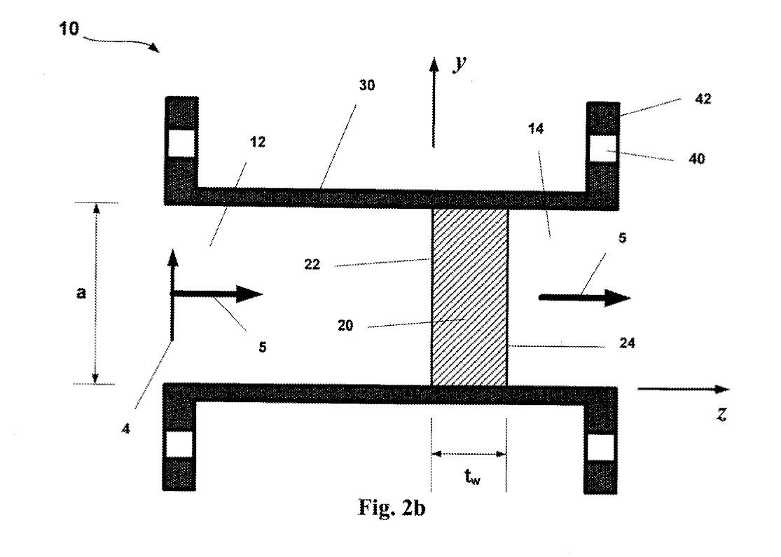

A cross section in the yz-plane of a truncated section of rectangular waveguide transmission line is shown in FIG. 2a. Waveguide broadwall 30, a connecting flange 42 and through holes 40 used to connect the waveguide section to other waveguide sections are shown in FIG. 2a. Also indicated in FIG. 2a is a waveguide window 20 that extends across the entire cross section of rectangular waveguide broadwall 30 and narrowwall 31. Shown in FIG. 2b is a cross section in the yz-plane of a truncated section of rectangular waveguide transmission line that is entirely filled with a microwave window 20. Standard microwave window 20 is commonly composed of a plastic (Teflon®, PVC, or other) or ceramic material (Alumina, or other) or non-ceramic (Boron Nitride, or similar). A propagating electromagnetic wave 5 is indicated in FIG. 2b, as well as polarization 4 of the electric field for the fundamental rectangular waveguide mode. Waveguide window 20 serves to physically separate a first region 12 from a second region 14 of the waveguide window assembly. Also indicated in FIG. 2b is front surface 22 of microwave window 20, bulk interior of microwave window 20, and rear surface 24 of microwave window 20. The thickness or length of microwave window 20 is indicated to be t_{w}, in FIG. 2b. Entire assembly 10 constitutes a rectangular waveguide window of the type well known in the art.

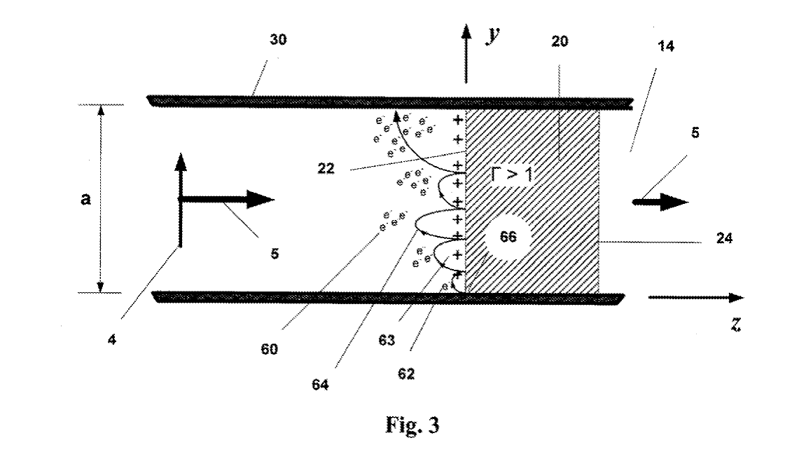

Referring now to FIG. 3, the multipactor phenomena is depicted. The phenomena of multipactor can be found in an evacuated waveguide transmission line that is operated at high levels of microwave power and that contains a dielectric interface. Shown in FIG. 3 is an illustration that depicts one initial seed electron 62 emitted from a geometrical triple point 66.

Seed electron 62 travels in the direction of the electric field polarization 4 of incident microwave signal 5. Due to the force produced by oppositely charged 63 dielectric interface surface 22 combined with electric field 4 and its associated magnetic field on electron 62, the electron travels back to the surface along a trajectory 64 and strikes the window interface. Under proper conditions multiplicatively more electrons 60 are ejected from surface 22. These electrons then experience a similar fate repeating the process that results in electron avalanche and electrical flashover and dielectric failure of the window. The accepted four step process for HPM window breakdown is: (1) field emission of a seed electron from a triple-point; (2) seed electrons strike the dielectric interface and secondary electron emission (SEE) from the dielectric cause an exponential increase and avalanche of electrons (multipactor); (3) electron-stimulated outgassing of the dielectric interface due to high energy electron bombardment of the surface; and (4) gaseous breakdown in the gas cloud above the interface. The window concept taught here directly suppresses the formation of multipactor by its geometry.

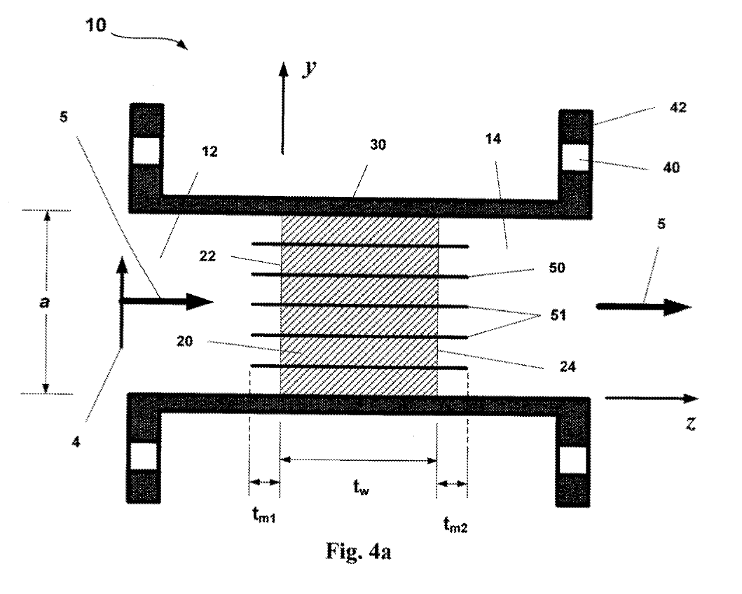

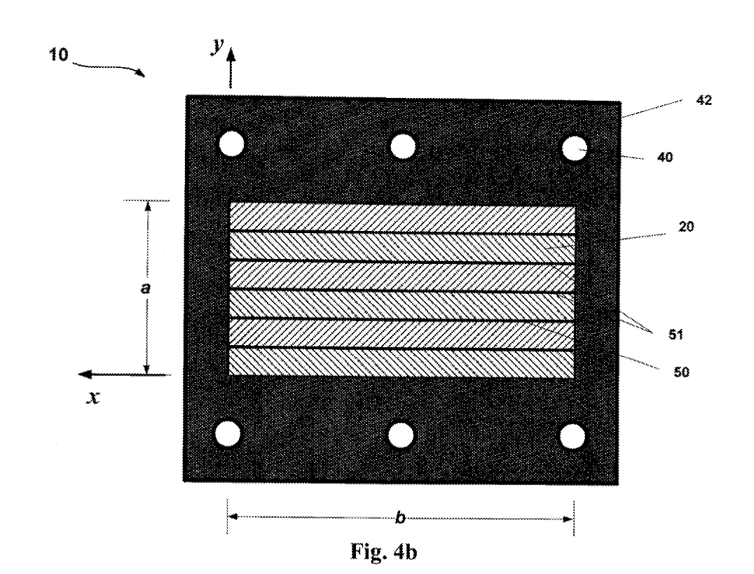

FIG. 4a and FIG. 4b depict a first preferred embodiment of the presently claimed invention as it relates to a high power-capable microwave window for waveguide transmission line, specifically, in this case a waveguide window 10 for standard rectangular waveguide operating in fundamental mode. High power-capable microwave window 10 comprises a section of rectangular waveguide with a flange 42 and bolt holes 40, a dielectric interface 22, a first septum 50 and a multitude of additional septa 51. In particular, a first septum 50 is introduced into the microwave window as shown in FIG. 4a. First septum 50 is made of a high conductivity metal. First septum 50 extends across the guide in a plane that is parallel to the broadwall of the rectangular waveguide. The thickness of first septum 50 is thin in the y-direction relative to the other physical dimensions of the waveguide and waveguide window. Due to its orientation, the plane of first septum 50 would be normal to polarization 4 of the electric field in the waveguide. Therefore the introduction of first septum does not perturb field distribution 4 or propagation 5 properties of the wave. Furthermore, in this first embodiment of the high power-capable microwave window, first septum extends entirely through dielectric interface 20. The width of first septum 50 is indicated to be t_{w}+tₘ₁+tₘ₂, which is necessarily greater than width t_{w} of dielectric interface 20. Dielectric interface 20 of the rectangular waveguide window divides window 10 into two regions. A first region 12 and a second region 14 of waveguide window 10 are indicated in FIG. 4a. Dielectric interface 20 can provide a hermetic seal between a first region 12 and a second region 14, such that first region 12 can be maintained at low vacuum and second region 14 can be maintained at high pressure, or at a separate vacuum level, or at some intermediate pressure.

As indicated in FIG. 4a and FIG. 4b, and depending on the specific design of the high power capable microwave window, additional and multiple septums 51 can be introduced into the bulk of dielectric window 22. As in the case of first or single septum 50, all additional septums 51, shown in cross section in the yz-plane in FIG. 4a and the xy-plane in FIG. 4b, extend from one narrowwall to the other such that they remain parallel to broadwall 30 of the guide. It is not required that the spacing between the septums in the y-direction be equal. The purpose and function of multitude of septa 51 is to inhibit surface flashover and inhibit the multipactor phenomena along first surface 22 and second surface 24 of the dielectric interface of waveguide window 10.

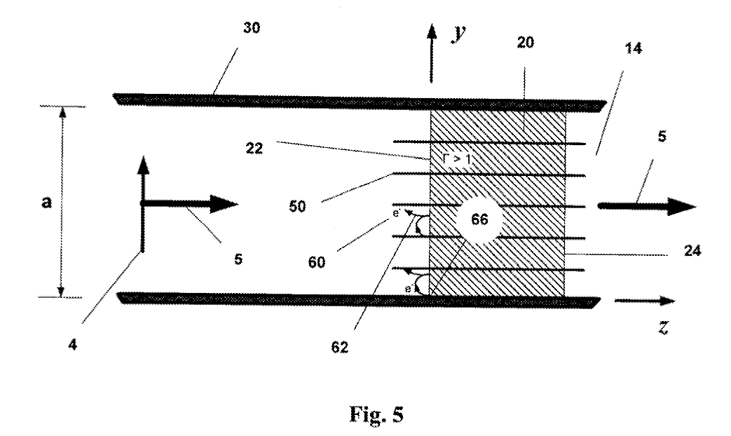

Referring now to the illustration of FIG. 5, the presence of metallic septa 50 are shown to intercept seed electrons 60. Furthermore, septa 50 provide a conduction path to the waveguide wall for intercepted charge. The interception of electrons 60 by septa 50 quenches the multipactor phenomena and prevents the charging of the interface. The split waveguide geometry suppresses the formation of multipactor by quenching the avalanching of electrons along the dielectric-vacuum interface. Reducing multipactor development will, in turn, suppress electron-induced out-gassing, which is the precursor to gaseous breakdown. Finally, if one considers the initiation of multipactor to come from stray “seed” electrons originating from operation of the source itself, we note that the design is robust in this regard as well, since it quenches the multipactor process regardless of the source of seed electrons.

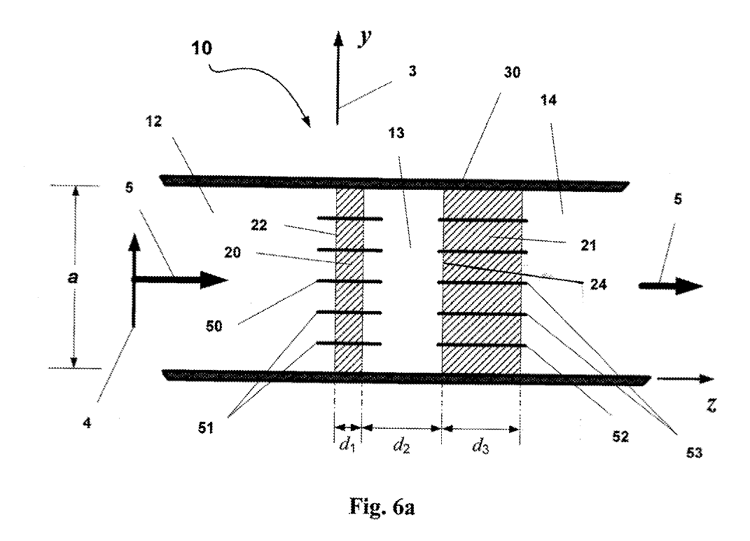

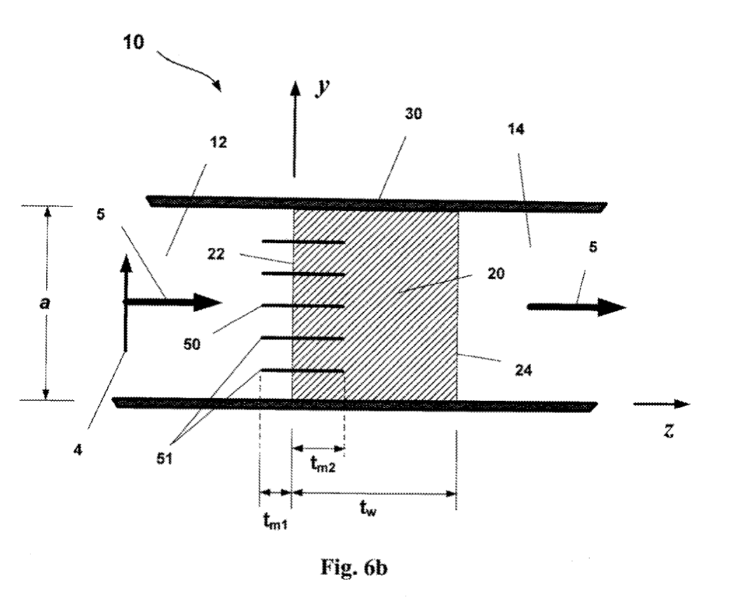

FIG. 6a depicts a yz-plane cross section of another embodiment of the presently claimed invention as it relates to a microwave window for waveguide transmission line, specifically, in this case a waveguide window 10 for standard rectangular waveguide operating in fundamental mode. The high power-capable microwave window 10 comprises a section of rectangular waveguide with a preferred orientation 3, a first bulk dielectric 20, a second bulk dielectric 21, a first dielectric surface 22, a second dielectric surface 24, a first waveguide window region 12, a second waveguide region 13, a third waveguide region 14, a first septum 50, a multitude of additional septa 51, another septum 52 and a multitude of other additional septa 53. In particular, a first septum 50 is introduced into a first bulk dielectric 20 of the microwave window 10 as shown in FIG. 6a. Additional septa 51 are also located in first bulk dielectric 20. First bulk dielectric 20 divides the waveguide window into a first region 12 and a second region 13. A second bulk dielectric segregates second waveguide window region 13 from a third waveguide window region 14. As indicated in FIG. 6a, the thickness of first bulk dielectric 20 is d₁, the thickness of the second bulk dielectric 21 is d₃ and the separation between the bulk dielectrics is d₂. The length diameters, and the relative permittivity and permeability of the bulk dielectric regions can be used to optimize the performance of waveguide window 10 with respect to bandwidth, power capability and transmission efficiency. For example, the hermetic seals provided by the bulk dielectric regions would allow for sustainment of low pressure in region one 12, high pressure gas or other vacuum in region two 13, and SF6 gas or other gas or other vacuum in region three 14. The parameters d₁, d₂and d₃, along with the values of relative permittivity and permeability of the bulk dielectric regions can be used to concentrate the electric field in region two 13 of the waveguide window, a region potentially well-insulated by standard atmospheric pressure, pressurized gas, or other vacuum.

FIG. 6b depicts a yz-plane cross section of another embodiment of the presently claimed invention as it relates to a microwave window for waveguide transmission line, specifically, in this case a waveguide window 10 for standard rectangular waveguide operating in fundamental mode. The high power-capable microwave window 10 comprises a section of rectangular waveguide 30, a first bulk dielectric 20, a first waveguide window region 12, a second waveguide region 14, a first septum 50, and a multitude of additional septa 51. In particular, first septum 50 is introduced into a first bulk dielectric 20 of the microwave window 10 as shown in FIG. 6b. The thickness of septum 50 is thin in the y-direction relative to the other physical dimensions of the waveguide and waveguide window. Due to its orientation, the plane of the septum would be normal to polarization 4 of the electric field in the waveguide. Therefore, the introduction of the septum does not perturb field distribution 4 or propagation 5 properties of the wave. Furthermore, in this embodiment of the high power-capable microwave window, septum 50 extends partially through bulk dielectric 20 a distance of tₘ₂, which may be zero; the zero value corresponds to contact but not penetration of the first dielectric surface 22. The width of septum 50 is indicated to be tₘ₁+tₘ₂, which may be less than the width t_{w} of dielectric interface 20. Additional septa 51 are also located in the first bulk dielectric 20. The width of septa 51 is indicated to be tₘ₁+tₘ₂, which may be less than the width t_{w} of dielectric interface 20, but can in general have widths that are unique from all other septa. First bulk dielectric 20 divides the waveguide window into a first region 12 and a second region 14.

The previous description of the disclosed embodiments is provided to enable any person skilled in the art to make or use the presently claimed invention. Various modifications to these embodiments will be readily apparent to those skilled in the art, and the generic principles defined herein may be applied to other embodiments without departing from the spirit or scope of the claimed invention. Thus, the presently claimed invention is not intended to be limited to the embodiments shown herein but is to be accorded the widest scope consistent with the principles and novel features disclosed herein.

What is claimed is:

1. A microwave waveguide window for transmitting high power, high intensity electromagnetic radiation comprising:
a solid body, the solid body including a first surface and a second surface spaced apart from one another in a first direction thereby defining a thickness of said solid body in said first direction;
a first septum, the septum including a first edge and a second edge spaced apart from one another in a first direction thereby defining a thickness of said septum in said first direction,
wherein the thickness of the said first septum in a said second direction perpendicular to the first direction is small relative to all other physical dimensions of the waveguide window or the electrical lengths associated with the transmitted electromagnetic radiation;
the said first septum is disposed such that it extends a length into said solid body such that the first and second surfaces of the said solid body and the first and second edges of the said septum are all aligned in the said first direction;
a flange disposed at a periphery of said solid body and said first septum such that a peripheral portion of said solid body and a peripheral portion of said septum comes into intimate contact with said flange.
